(19) United States
(12) Patent Application Publication
(10) Pub. No.: US 2001/0017996 A1
(43) Pub. Date: Aug. 30, 2001

(54) Image forming apparatus

(75) Inventor: Keisuke Shinoda, Tokyo (JP)

Correspondence Address: OSTROLENK FABER GERB & SOFFEN, 1180 AVENUE OF THE AMERICAS, NEW YORK, NY, 100368403

(73) Assignee: NEC Corporation

(21) Appl. No.: 09/778,559

(22) Filed: Feb. 7, 2001

(30) Foreign Application Priority Data
Feb. 24, 2000 (JP) 2000-047357

(51) Int. Cl. G03G 15/10

(52) U.S. Cl. 399/249

(57) ABSTRACT

An image forming apparatus will never cause unevenness of field gap in an axial direction of a squeezing roller, can efficiently clean the squeezing roller, and can prevent wearing of a tip end portion of a cleaning blade due to rubbing to provide longer life. The image forming apparatus has a spacer maintaining a given clearance between a cylindrical outer peripheral surface of the squeezing roller and a cylindrical outer peripheral surface of the cleaning roller.

### BACKGROUND OF THE INVENTION

1. Field of the Invention

The present invention relates generally to an image forming apparatus. More particularly, the invention relates to an image forming apparatus having a squeezing roller for applying a pressure in order to remove a solvent in a liquid toner from an image developed on a photoconductive drum which is formed with a photoconductor on a surface thereof.

2. Description of the Related Art

Conventionally, as shown in FIG. 5, in an image forming apparatus having a squeezing roller 17 for removing a solvent in a liquid toner from an image developed on a photoconductor belt 15, it has been known that a load distribution in a roller axis direction between a squeezing roller 17 and a back-up roller 18 is required to achieve uniform drying ratio over the entire image. For this purpose, a surface elastic body of the squeezing roller 17 is formed into crown shape.

However, in the conventional image forming apparatus constructed as set forth above, in order to clean a toner particle mechanically or electrically deposited on the squeezing roller 17, a cleaning roller 16 electrically removing the toner particle on the squeezing roller 17 is provided at opposite position to contacting surface with the photoconductor belt 15. Since the surface elastic body of the squeezing roller 17 is formed into crown shape, field gap in the axial direction of the squeezing roller tend to be non-uniform.

On the other hand, in the conventional image forming apparatus, position of a mounting tip end portion of a not shown cleaning blade which is provided for performing cleaning of the toner particle electrically deposited on the cylindrical outer periphery of the cleaning roller 16, should contact with stirring hair of a not shown brush roller provided for removing toner particle firmly stack on the tip end portion to be significantly worn due to rubbing of the tip end portion of the cleaning blade.

### SUMMARY OF THE INVENTION

The present invention has been worked out for solving a problem in the conventional image forming apparatus as set forth above. Therefore, it is an object of the present invention to provide an image forming apparatus which will never cause unevenness of field gap in an axial direction of a squeezing roller, can efficiently clean the squeezing roller, and can prevent wearing of a tip end portion of a cleaning blade due to rubbing to provide longer life.

In order to accomplish the above-mentioned and other objects, an image forming apparatus, in accordance with one aspect of the present invention, comprises:

a liquid toner dispersing a toner in a solvent;

a squeezing roller applying a predetermined pressure on the liquid toner on the photoconductor belt for removing the solvent in the liquid toner from an image developed on the photoconductor belt;

a cleaning roller arranged at a position opposing to the squeezing roller for removing a toner particle depositing on a cylindrical outer peripheral surface of the squeezing roller by application of a voltage; and

a spacer maintaining a given clearance between a cylindrical outer peripheral surface of the squeezing roller and a cylindrical outer peripheral surface of the cleaning roller.

With the invention set forth above, since the clearance between the cylindrical outer peripheral surface of the squeezing roller and the cylindrical outer peripheral surface of the cleaning roller can be maintained constant, a field gap will never become uneven in the axial direction of the squeezing roller to permit efficient cleaning of the squeezing roller.

In the preferred construction, the squeezing roller may include

a cylindrical bare pipe;

an elastic body attached on a cylindrical outer peripheral surface of the bare pipe; and

a shaft extending through the bare pipe,

the bare pipe and the shaft being connected at two points at substantially central portion in the axial direction of the squeezing roller.

Accordingly, the pressure between the photoconductor belt and the squeezing roller in the axial direction of the roller can be made uniform, and the clearance between the squeezing roller and the constant cleaning roller can be maintained constantly without being influence by deflection of the squeezing roller due to high load.

The spacer may be a disc provided at an end portion of the cleaning roller for rotating integrally.

Accordingly, with simple construction, the constant clearance between the cylindrical outer peripheral surface of the squeezing roller and the cylindrical outer peripheral surface of the cleaning roller can be maintained.

Also, the disc may be attached on the cylindrical outer peripheral surface of the squeezing roller.

The disc may contact with the cylindrical outer peripheral surface of the bare pipe of the squeezing roller.

The disc may be fixed to a rotary shaft of the cleaning roller.

By the construction set forth above, depending upon the size of the disc as the spacer, the clearance between the cleaning roller and the squeezing roller can be adjusted.

In the preferred construction, in the image forming apparatus, an engaging dimension between an external diameter of a bearing portion of the cleaning roller and an internal diameter of the bearing may be set with a sufficient clearance and only dimension of only a radial thickness portion of the disc is defined, a clearance between the squeezing roller and the cleaning roller may be maintained constant without intervention of the engaging tolerance or the like.

Accordingly, since the constant clearance between the squeezing roller and the cleaning roller can be maintained by defining only dimension of the thickness portion of the disc as the spacer, manufacturing of the image forming apparatus can be facilitated.

The image forming apparatus may further comprise a cleaning blade contacting a tip end thereof with the outer peripheral surface of the cleaning roller for removing toner particle electrically depositing on the outer peripheral surface of the cleaning roller, and a liquid toner storage portion for storing the liquid toner is defined around the tip end portion.

Accordingly, with the stored liquid toner, the toner particle fixedly stack on the tip end portion of the cleaning blade can be removed and does not require contacting of the tip end of the brush of the brush roller to the tip end portion of the cleaning blade.

The liquid toner storage portion may be variable of liquid toner storage amount.

By this, the cleaning effect of the tip end portion of the cleaning blade can be adjusted.

### BRIEF DESCRIPTION OF THE DRAWINGS

The present invention will be understood more fully from the detailed description given hereinafter and from the accompanying drawings of the preferred embodiment of the present invention, which, however, should not be taken to be limitative to the invention, but are for explanation and understanding only.

In the drawings:

FIG. 1 is an illustration showing an overall construction of one embodiment of an image forming apparatus according to the present invention;

FIG. 2 is a partial section showing one example of a construction of a squeezing roller and cleaning roller of the image forming apparatus of FIG. 1;

FIG. 3 is a partial section showing another example of a construction of a squeezing roller and cleaning roller of the image forming apparatus of FIG. 1;

FIG. 4 is a general illustration for explaining a relationship between a spacer disc and a bearing of the image forming apparatus of FIG. 1; and

FIG. 5 is a general illustration showing one example pf the conventional image forming apparatus.

### DESCRIPTION OF THE PREFERRED EMBODIMENT

The present invention will be discussed hereinafter in detail in terms of the preferred embodiment of the present invention with reference to the accompanying drawings. In the following description, numerous specific details are set forth in order to provide a thorough understanding of the present invention. It will be obvious, however, to those skilled in the art that the present invention may be practiced without these specific details. In other instance, well-known structure are not shown in detail in order to avoid unnecessary obscurity of the present invention.

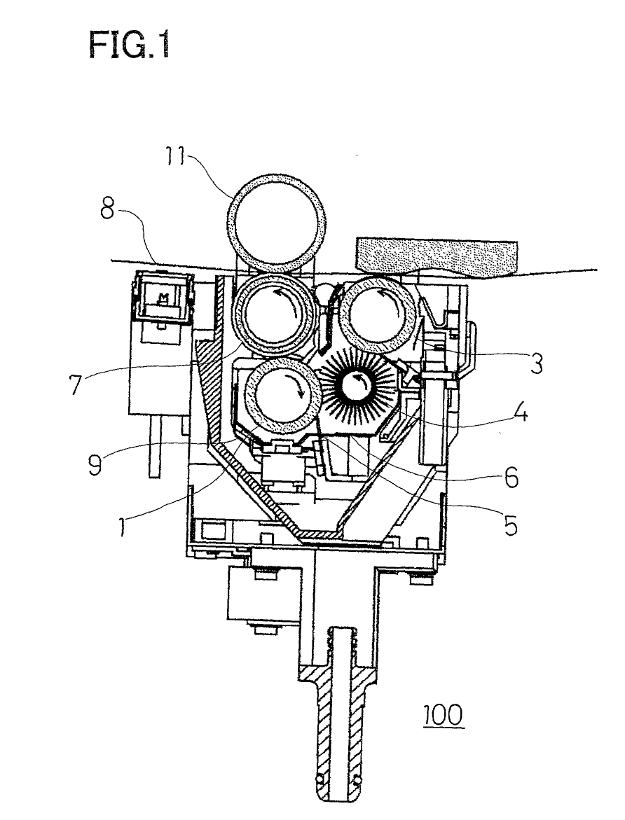

FIG. 1 shows one embodiment of an image forming apparatus according to the present invention. The image forming apparatus 100 is an image forming apparatus employing a liquid toner and is constructed with a photoconductor belt 8, a developer roller 3, a squeezing roller 7, a back-up roller 11, a cleaning roller 1, a brush roller 4, a cleaning blade 5 and a reservoir 6 and so forth.

All of components other than squeezing roller 7 are supported by a not shown side plate. Also, components other than the side plate and the squeezing roller 7 are inserted in a shaft of the developer roller 3 for pendulum swing like pivotal motion. In order to cause pendulum swing, a not shown bias spring is arranged on a bottom surface of the side plate.

On the side plate, the brush roller 4 is rotatably provided with a given penetration amount to the cleaning roller 1 in order to stir a liquid toner and removal of toner particle firmly sticking on a tip end portion of the cleaning blade 5.

The cleaning roller 1 is inserted in the side plate and is supported rotatably.

The cleaning blade 5 is provided for cleaning the toner particle electrically depositing on the cylindrical outer peripheral surface of the cleaning roller 1. A tip end portion of the cleaning blade 5 contacts on the outer peripheral surface of the cleaning roller 1. It should be noted that the cleaning blade 5 and the brush roller 4 are arranged so as not to contact with each other.

The reservoir 6 is surrounded by the cleaning roller 1, the brush roller 4 and the cleaning blade 5. The inside of the reservoir 6 serves as a liquid toner storage portion for storing a liquid toner. On the other hand, in the reservoir 6, a support 9 for adjusting filling height of the liquid toner stored therein, is secured at variable position.

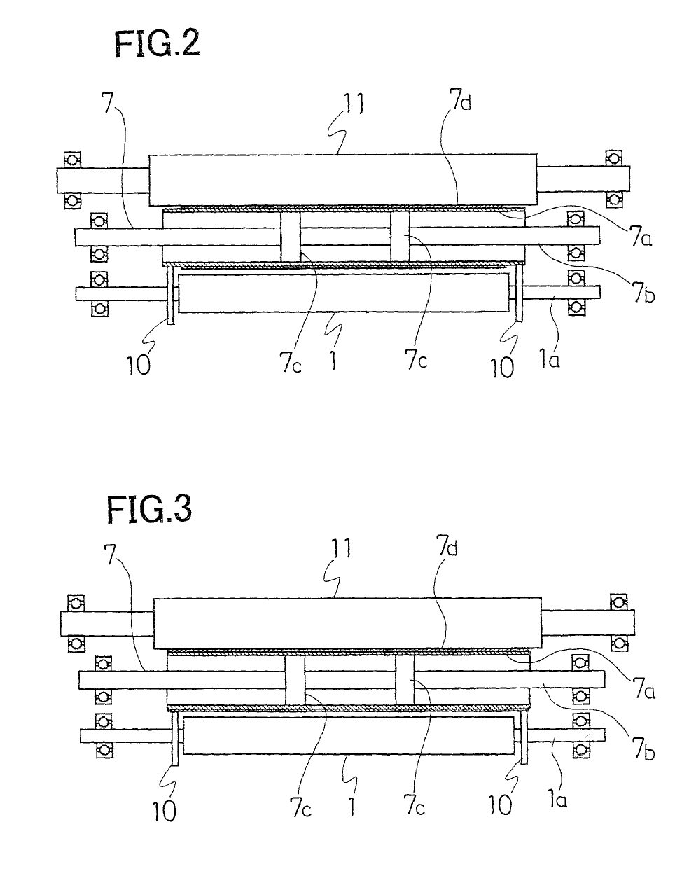

The squeezing roller 7 is directly driven to contact with the photoconductor belt 8 under pressure. At this time, a pressure contact load becomes about 30 kgf to cause mechanical deflection in the squeezing roller 7 by the high load. The squeezingroller7 includes a cylindrical bare pipe 7a, an elastic body 7d attached on the cylindrical outer peripheral surface of the bare pipe 7a and a shaft extending through the center of the bare pipe 7a, as shown in FIG. 2. The bare pipe 7a and the shaft 7b are connected at two connecting portions 7c at substantially central portion in the axial direction of the squeezing roller 7. By this, mechanical deflection to be caused upon contacting with the photoconductor belt 8 under pressure can be minimized.

As shown in FIG. 2, on a rotary shaft la of the cleaning roller 1, a spacer disc 10 having a diameter greater than that of the cleaning roller 1 is provided. Thespacerdiscl0contacts with the cylindrical outer peripheral surface of the bare pipe 7a of the squeezing roller 7 under pressure to rotate integrally with the cleaning roller 1. Thus, a clearance between the squeezing roller 7 and the cleaning roller 1 can be maintained constant. As shown in FIG. 3, by pressure contact of the spacer disc 10 onto the cylindrical outer peripheral surface of the elastic body 7d of the squeezing roller 7, it becomes possible to maintain the clearance between the squeezing roller 7 and the cleaning roller 1 constant.

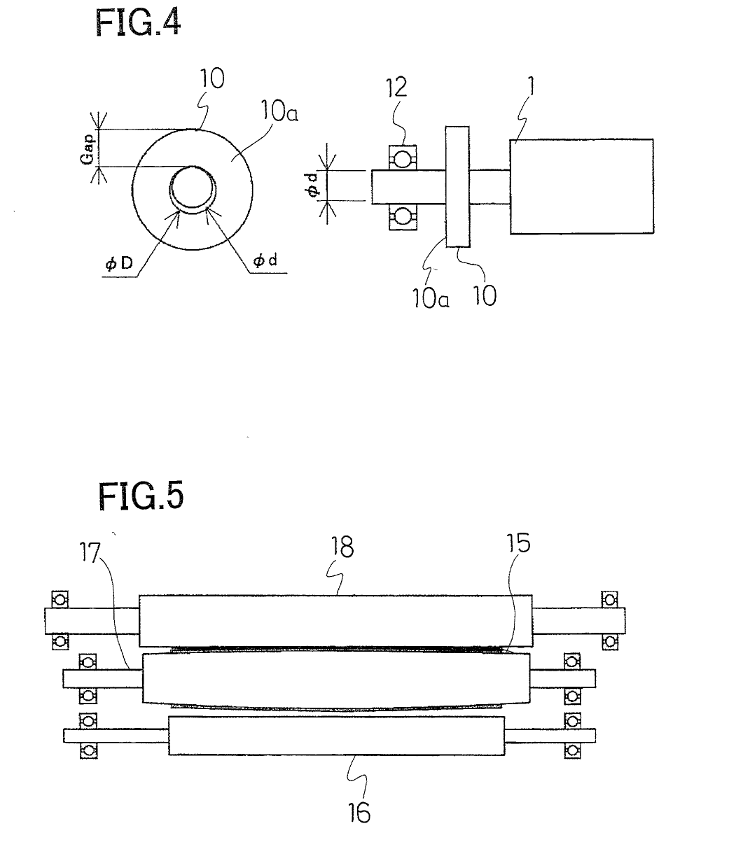

On the other hand, as shown in FIG. 4, by setting an engagement dimension between an external diameter φd of a bearing portion of the cleaning roller land an internal diameter φD of the bearing with sufficient clearance, and defining only dimension (Gap) of a radial thick portion 10a as a difference between an external diameter and an internal diameter of the spacer disc 10, the clearance between the squeezing roller 7 and the cleaning roller 1 can be maintained constant without intervention of engaging tolerance or the like. Assembling of the image forming apparatus 100 is facilitated.

Next, operation of the image forming apparatus 100 constructed as set forth above, will be discussed with reference to the drawings.

When the side plate is pivoted about the shaft of the developer roller 3 like pendulum swing, the cleaning roller 1 is rotated until the spacer disc 10 at both ends of the cleaning roller 1 comes into contact with the squeezing roller 7 to maintain constant clearance between the cylindrical outer peripheral surface of the squeezing roller 7 and the cylindrical output peripheral surface of the cleaning roller 1. By this, upon cleaning the toner particle mechanically and electrically depositing on the squeezing roller 7, unevenness of field gap in the axial direction of the squeezing roller 7 will never be caused and cleaning of the squeezing roller 7 can be performed efficiently.

After pressure contact with the squeezing roller 7, the spacer disc 10 is rotated by contact friction resistance and thus will never interfere rotation of the squeezing roller 7 to maintain smooth rotation of the squeezing roller 7.

When image forming operation is performed and when the solvent of the liquid toner is removed from the image developed on the photoconductor belt 8, it becomes necessary to establish uniform load distribution between the squeezing roller 7 and the back-up roller 11 in axial direction of the roller in order to attain uniform drying ratio over the entire image as set forth above. In the present invention, since the mechanical deflection caused upon contacting the squeezing roller 7 with photoconductor belt 8 under pressure, is minimized, uniform load distribution in the axial direction of the roller can be established between the squeezing roller 7 and the back-up roller 11 even when the surface elastic body of the squeezing roller 7 is not formed into crown shape.

On the other hand, the support 9 adjusting filling height of the liquid toner stored in the reservoir 6 is mounted on the side surface of the reservoir 6 and is not positioned. After moving to desired height position, the support 9 is secured on the side surface of the reservoir.

It should be noted that in the shown embodiment, for making the pressure between the photoconductor belt 8 and the squeezing roller in the axial direction uniform and for constantly maintaining the uniform clearance between the squeezing roller 7 and the cleaning roller 1 without being influencedby deflection of the squeezing roller 7 at high load, the bare pipe 7a and the shaft 7b of the squeezing roller 7 are connected at two points at substantially center portion in the axial direction of the squeezing roller 7, another other construction may be employed as long as the unification of the pressure and maintaining of the clearance can be achieved.

Also, while the side plate and the components mounted thereon take the shaft of the developer roller as fulcrum of rotating motion, any appropriate shaft other than the shaft of the developer roller 3 may also be taken as fulcrum of rotating motion.

Furthermore, the support 9 for adjusting filling height of the liquid toner to be stored in the reservoir 6 may be separated from the reservoir upon height adjustment and is coupled subsequently. It is only required to variably define the upper limit in storing the liquid toner in the reservoir.

As set forth above, with the present invention, it becomes possible to provide the image forming apparatus, in which since the pressure between the photoconductor belt and the squeezing roller is maintained uniform in the roller axis direction, the field gap in the axial direction of the squeezing roller will never become uneven, and since the clearance between the squeezing roller and the cleaning roller can be constantly maintained constant without being influenced by deflection of the squeezing roller due to high load, cleaning of the squeezing roller can be efficiently performed.

Also, with the present invention, an image forming apparatus having long life can be provided since the toner particle firmly stack on the tip end portion of the cleaning blade can be removed without requiring contacting the tip end of the brush of the brush roller with the tip end of the cleaning blade, and preventing wearing due to rubbing of the tip end of the cleaning blade.

What is claimed is:

1. An image forming apparatus comprising:
a liquid toner dispersing a toner in a solvent;
a squeezing roller applying a predetermined pressure on said liquid toner on said photoconductor belt for removing said solvent in said liquid toner from an image developed on said photoconductor belt;
a cleaning roller arranged at a position opposing to said squeezing roller for removing a toner particle depositing on a cylindrical outer peripheral surface of said squeezing roller by application of a voltage; and
a spacer maintaining a given clearance between a cylindrical outer peripheral surface of said squeezing roller and a cylindrical outer peripheral surface of said cleaning roller.

2. An image forming apparatus as set forth in claim 1, wherein said squeezing roller includes
a cylindrical bare pipe;
an elastic body attached on a cylindrical outer peripheral surface of said bare pipe; and
a shaft extending through said bare pipe,
said bare pipe and said shaft being connected at two points at substantially central portion in the axial direction of the squeezing roller.

3. An image forming apparatus as set forth in claim 1, wherein said spacer is a disc provided at an end portion of said cleaning roller for rotating integrally.

4. An image forming apparatus as set forth in claim 3, wherein said disc is attached on the cylindrical outer peripheral surf ace of said squeezing roller.

5. An image forming apparatus as set forth in claim 3, wherein said disc contacts with the cylindrical outer peripheral surface of the bare pipe of said squeezing roller.

6. An image forming apparatus as set forth in claim 3, wherein said disc is fixed to a rotary shaft of said cleaning roller.

7. An image forming apparatus as set forth in claim 6, wherein an engaging dimension between an external diameter of a bearing portion of said cleaning roller and an internal diameter of said bearing is set with a sufficient clearance and only dimension of only a radial thickness portion of said disc is defined, a clearance between said squeezing roller and said cleaning roller is maintained constant without intervention of said engaging tolerance or the like.

8. An image forming apparatus as set forth in claim 1, which further comprises a cleaning blade contacting a tip end thereof with the outer peripheral surface of said cleaning roller for removing toner particle electrically depositing on the outer peripheral surface of said cleaning roller, and a liquid toner storage portion for storing said liquid toner is defined around said tip end portion.

9. An image forming apparatus as set forth in claim 8, wherein said liquid toner storage portion is variable of liquid toner storage amount.
